(19) United States
(12) Patent Application Publication
(10) Pub. No.: US 2025/0158298 A1
(43) Pub. Date: May 15, 2025

(54) VERTICAL INSULATION PIERCING ELECTRICAL CONNECTOR

(71) Applicant: Hubbell Incorporated, Shelton, CT (US)

(72) Inventor: Colin Marshall Alexander Rebhun, Manchester, NH (US)

(21) Appl. No.: 18/947,338

(22) Filed: Nov. 14, 2024

Related U.S. Application Data
(60) Provisional application No. 63/599,124, filed on Nov. 15, 2023.

(51) Int. Cl. H01R 4/2458

(52) U.S. Cl. CPC H01R 4/2458

(57) ABSTRACT

An electrical connector includes a base. A lower clamp is connected to the base. The lower clamp includes a conductor groove for receiving a conductor. The conductor has an axial direction and a radial direction. An inner clamp is connected to the base and moveable with respect to the lower clamp. An upper clamp is connected to the base and moveable with respect to the lower clamp. A first insulation piercing member is connected to the lower clamp. The first insulation piercing member includes a plurality of first teeth. The plurality of first teeth are spaced from one another in the radial direction. A second insulation piercing member is connected to the inner clamp. A third insulation piercing member is connected to the upper clamp.

### RELATED APPLICATION(S)

This application is based on U.S. Provisional Application Ser. No. 63/599,124, filed Nov. 15, 2023, the disclosure of which is incorporated herein by reference in its entirety and to which priority is claimed.

### FIELD

Various exemplary embodiments relate to an insulation piercing connector for electrically connecting two or more conductors.

### BACKGROUND

A power line clamp connector is used to make a permanent or temporary connection to an overhead power distribution line. For example, cable clamps are configured to electrically connect a main conductor to a tap conductor running parallel to the main conductor. Typical cable clamps utilize a parallel cable clamp with a top half and a bottom half, each having a first groove for receiving the main conductor and a second groove for receiving the tap conductor. The top and bottom halves are typically held together by a mechanical fastener.

### SUMMARY

An electrical connector includes one or more moveable clamping members to secure a conductor. Insulation piercing teeth are used to pierce the insulation of a conductor to form an electrical connection.

In certain configurations, an electrical connector includes insulation piercing teeth that are oriented at different angles to one another to provide a more secure connection.

In certain configurations the electrical connector includes insulation piercing teeth positioned inside of a gasket to form a seal. The teeth can be positioned below an outer edge of the gasket in an unstressed position.

In certain configurations, an electrical connector includes a base. A lower clamp is connected to the base. The lower clamp includes a conductor groove for receiving a conductor. The conductor has an axial direction and a radial direction. An inner clamp is connected to the base and moveable with respect to the lower clamp. An upper clamp is connected to the base and moveable with respect to the lower clamp. A first insulation piercing member is connected to the lower clamp. The first insulation piercing member includes a plurality of first teeth. The plurality of first teeth are spaced from one another in the radial direction. A second insulation piercing member is connected to the inner clamp. A third insulation piercing member is connected to the upper clamp.

In certain configurations, an electrical connector includes a base and a lower clamp integrally formed with the base. The lower clamp includes a conductor groove for receiving a conductor. The conductor has an axial direction and a radial direction. An inner clamp is connected to the base and moveable with respect to the lower clamp. An upper clamp is connected to the base and moveable with respect to the lower clamp. A fastener extends through at least a portion of the base, the inner clamp, and the upper clamp. A first insulation piercing member is connected to the lower clamp. The first insulation piercing member includes a plurality of first teeth, wherein the plurality of first teeth are spaced from one another in the radial direction. A second insulation piercing member is connected to the inner clamp. The second insulation piercing member includes a lower set of teeth extending toward the lower clamp and the lower set of teeth are spaced from each other in the axial direction. A third insulation piercing member connected to the upper clamp.

In certain configurations, an electrical connector includes a base and a lower clamp connected to the base. The lower clamp includes a conductor groove for receiving a conductor. The conductor has an axial direction and a radial direction. An inner clamp is connected to the base and moveable with respect to the lower clamp. An upper clamp is connected to the base and moveable with respect to the lower clamp. A first insulation piercing member is connected to the lower clamp. The first insulation piercing member includes a plurality of first teeth extending in a first direction. A second insulation piercing member is connected to the inner clamp. The second insulation piercing member includes a plurality of second teeth extending in a second direction. A third insulation piercing member connected to the upper clamp.

### BRIEF DESCRIPTION OF THE DRAWINGS

The aspects and features of various exemplary embodiments will be more apparent from the description of those exemplary embodiments taken with reference to the accompanying drawings.

FIG. 1 is a front perspective view of an exemplary connector.

FIG. 2 is a rear perspective view of FIG. 1.

FIG. 3 is a front perspective view of the base and the lower clamp.

FIG. 4 is a front perspective view of the inner clamp.

FIG. 5 is a front perspective view of the upper clamp.

FIG. 6 is a front perspective view of the lower gasket.

FIG. 7 is a front perspective view of an inner gasket.

FIG. 8 is a front perspective view of the inner clamp and the inner piercing member.

FIG. 9 is a front perspective view of the lower clamp and the lower piercing member.

FIG. 10 is a front perspective view of the upper clamp and the upper piercing member.

FIG. 11 is a sectional view of FIG. 1.

### DETAILED DESCRIPTION OF EXEMPLARY EMBODIMENTS

According to various exemplary embodiments, a vertical, parallel groove, insulation piercing connector clamp can be used for tap, splice, and dead-end connections in various utility line operations. The clamp can include at least an upper cable receiving region and a lower cable receiving region. The upper and lower cable receiving regions are configured to receive a cable running in an axial direction. One or more insulation piercing members are associated with each of the upper and lower regions and a middle region. Two or more conductors can be inserted into the clamp and the clamp can be tightened so that the insulation piercing members pierce the respective insulations and the conductors are held in place by the clamp. An electrical connection can be formed between the two or more conductors. For example, a tap line can be positioned in the clamp and the clamp can be connected to a primary line. Once the clamp is tightened, an electrical connection is formed between the primary and tap line.

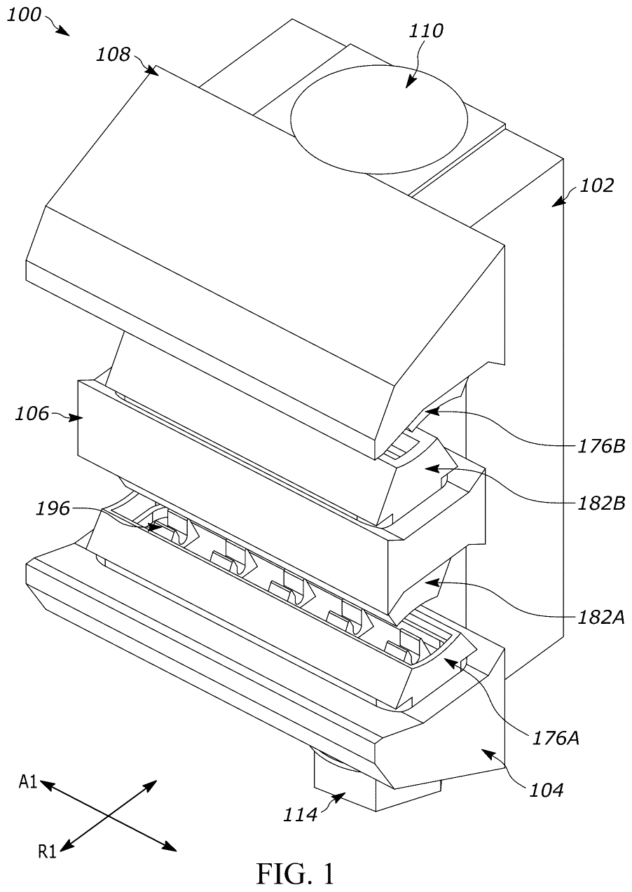

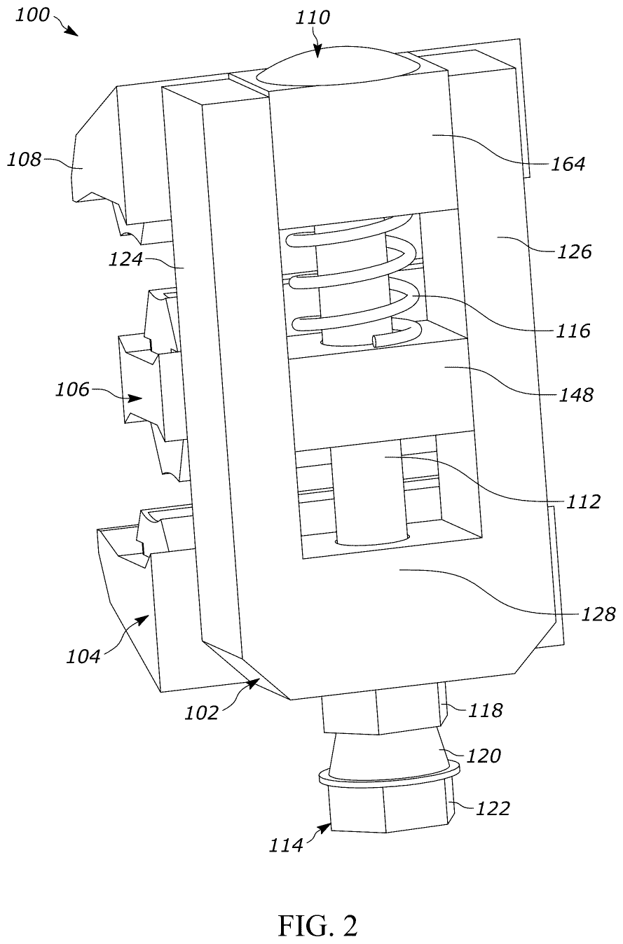

FIGS. 1 and 2 show an exemplary embodiment of a connector 100 having a base 102, a lower clamp member 104, an inner clamp member 106, and an upper clamp member 108. A fastener 110 can moveably connect the inner clamp member 108 and at least one of the lower clamp 104 and/or upper clamp 108 to the base. In certain configurations the base 102 and the lower clamp member 104 can be fixed and/or integrally formed while the inner clamp member 106 and the upper clamp member 108 are moveably connected by the fastener 110. Each of the clamp members 104, 106, 108 can include at least one insulation displacing member. In certain configurations, one or more gaskets can also be associated with each clamp member 104, 106, 108. The clamp is configured to receive and retain conductors running in an axial direction A1.

In various embodiments, the fastener 110 can include a bolt 112 and a shear nut 114. In certain configurations, the bolt 112 can include a head that is captured in the upper clamp 108 and have a shaft that extends through the inner clamp 106 and the base 102. The bolt 112 can also extend through a biasing member 116, for example a coil spring, positioned between the upper clamp 108 and the inner clamp 106. The shear nut 114 can include an upper engagement portion 118, a frangible section 120, and a lower engagement portion 122. A tool can be used to tightening the shear nut using the lower engagement portion 122 until a certain torque limit is reached and the frangible section 120 shears to remove the lower engagement portion 122. This helps prevent overtightening of the fastener 110 which can cause damage to the connector or to the conductors.

In the illustrated configuration, the biasing member 116 biases the inner clamp 106 toward the lower clamp 104. Tightening the shear nut 114 can pull the head of the bolt 112 down so that the upper clamp 108 moves toward the lower clamp 104. The biasing member 116 biases the inner clamp 106 so that it will move with the upper clamp 108 through a first range of motion before the biasing member 116 is compressed and the amount of force exerted on the inner clamp 106 is increased.

In an exemplary embodiment, the base 102 has a substantially U-shaped configuration with a first arm 124, a second arm 126, and a crossbar 128. An opening is provided in the crossbar 128 to receive the bolt 112. The lower clamp 104 can extend from the crossbar 128. The first arm 124 and the second arm 126 are spaced to receive a portion of the inner clamp 106 and the upper clamp 108.

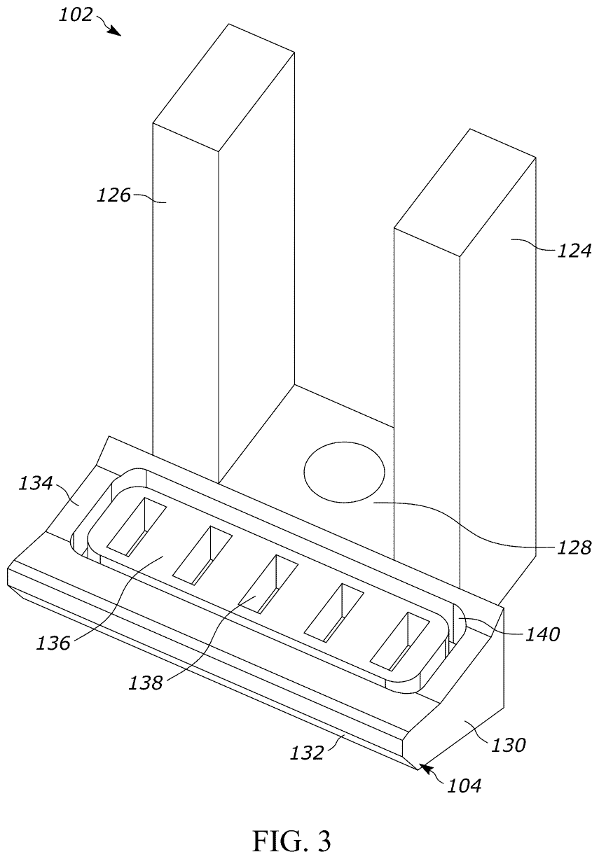

In certain configurations, the lower clamp 104 can be formed integrally with the base 102 as best shown in FIG. 3. In the illustrated embodiment, the lower clamp 104 has a lower body 130 with a lower wall 132 that angles upwardly toward the upper clamp 108. The lower body 130 can include a lower groove 134 for receiving a conductor. A lower piercing member retainer 136 is formed in the lower body 130. The lower piercing member retainer 136 can include a plurality of slots 138 for receiving one or more insulation piercing members. A lower channel 140 is formed around the lower piercing member retainer 136. The lower channel 140 can be configured to receive one or more gaskets.

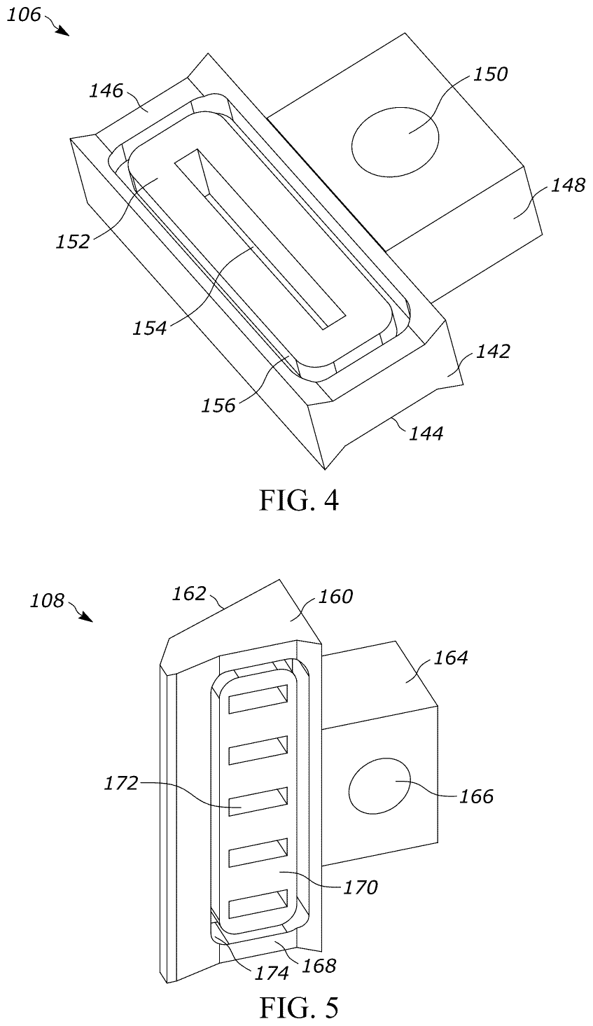

FIG. 4 shows an exemplary embodiment of the inner clamp 106. The inner clamp 106 can include an inner clamp body 142 having a first conductor groove 144 facing the lower clamp 104 and a second conductor groove 146 facing the upper clamp 108. A projection 148 extends from the inner clamp body 142 which is received between the first arm 124 and the second arm 126 of the base 102. An opening 150 is formed in the projection for receiving the bolt 112. An inner piercing member retainer 152 is formed in the inner clamp body 142. A slot 154 can extend through the inner piercing member retainer 152 to receive an insulation piercing member. A first channel 156 and a second channel 158 are formed around the inner piercing member retainer 152. The channels 156, 158 can be configured to receive one or more gaskets.

FIG. 5 shows an exemplary embodiment of the upper clamp 108. The upper clamp 108 has an upper body 160 with an upper wall 162 that angles downwardly toward the lower clamp 104. A projection 164 extends from the upper clamp body 160 which is received between the first arm 124 and the second arm 126 of the base 102. An opening 166 is formed in the projection 164 for receiving the bolt 112. The upper body 160 can include an upper groove 168 for receiving a conductor. An upper piercing member retainer 170 is formed in the upper body 160. The upper piercing member retainer 170 can include a plurality of slots 172 for receiving one or more insulation piercing members. An upper channel 174 is formed around the upper piercing member retainer 170. The upper channel 174 can be configured to receive one or more gaskets.

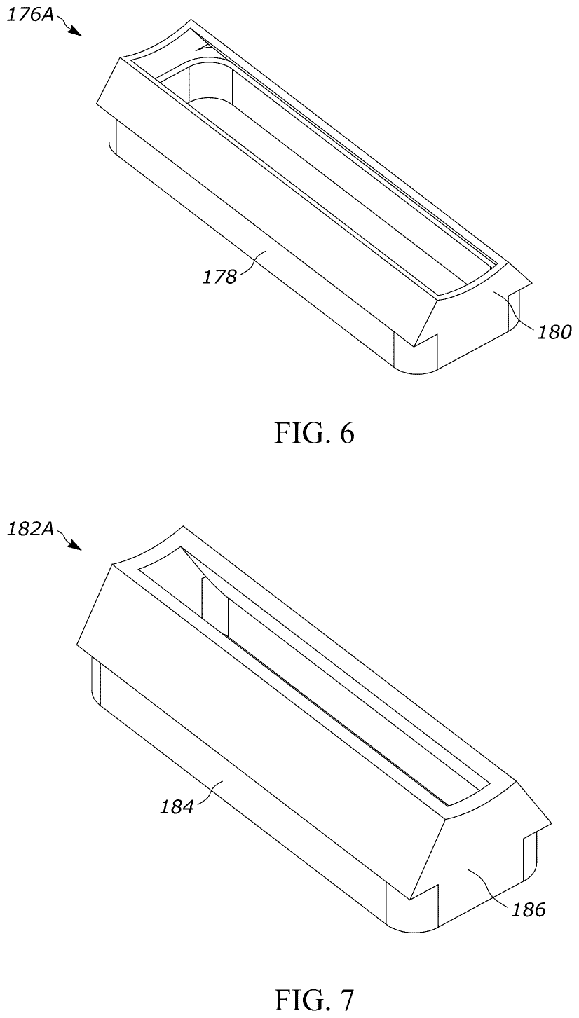

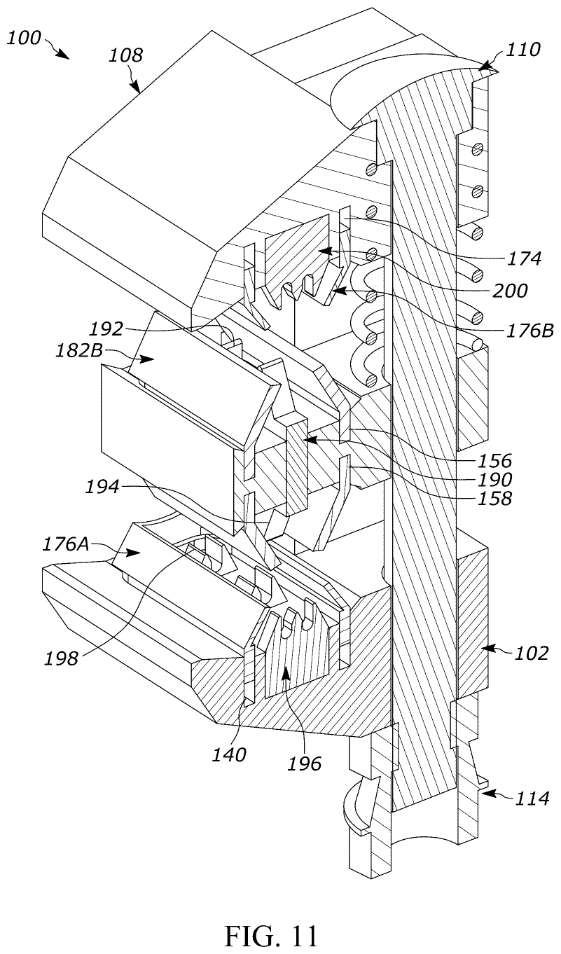

FIG. 6 shows an exemplary embodiment of a lower gasket 176A. The lower gasket 176A can have a lower flange 178 and an upper portion 180 with a frustum-pyramid configuration. The frustum can be curved to seal against a seated conductor. An upper gasket 176B can have an identical configuration. The lower gasket 176A can be seated in the lower channel 140 and the upper gasket 176B can be seated in the upper channel 174 as shown in FIGS. 1 and 11.

Similarly, FIG. 7 shows an exemplary embodiment of a first inner gasket 182A. The first inner gasket 182A can have a lower flange 184 and an upper portion 186 with a frustum-pyramid configuration. The frustum can be curved to seal against a seated conductor. A second inner gasket 182B can have an identical configuration. The first inner gasket 182A can be seated in the first inner channel 156 and the second inner gasket can be seated in the second inner channel 158 as shown in FIGS. 1 and 11.

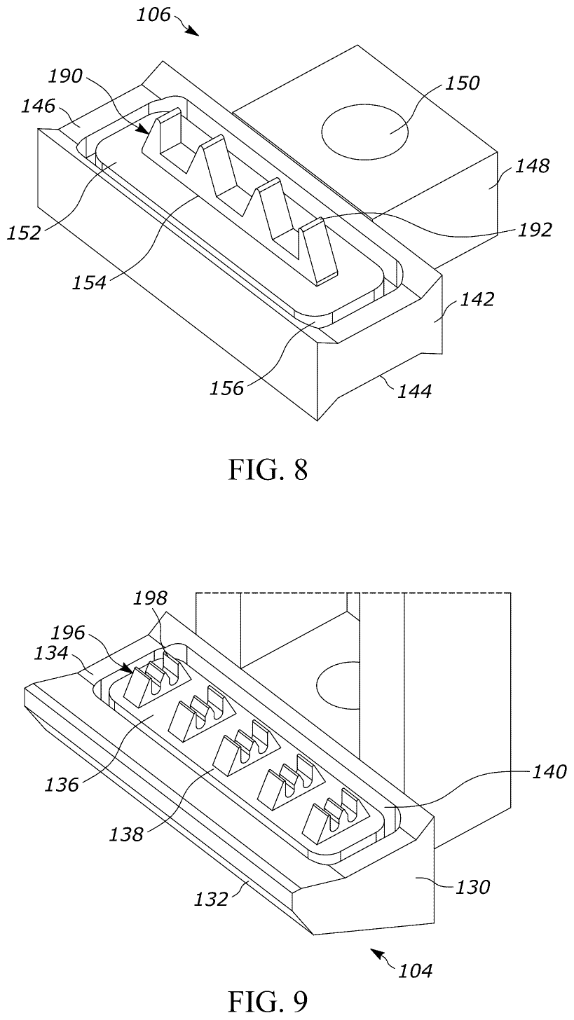

FIG. 8 shows an exemplary embodiment of an inner piercing member 190 positioned in the inner piercing member retainer. The inner piercing member 190 has a first set of teeth 192 extending toward the lower clamp 104 and a second set of teeth 194 extending toward the upper clamp 108. In certain configurations the teeth 192, 194 have a substantially triangular configuration which ends in a point. The teeth 192, 194 are oriented in the axial direction A1 of the conductor, that is, the teeth 192, 194 are spaced from one another along the axial direction A1 with the points of the teeth 192, 194 having a width extending in the radial direction R1.

FIG. 9 shows an exemplary embodiment of a set of lower piercing members 196 positioned in the lower piercing member retainer 136. Each of the lower piercing members 196 includes a plurality of teeth 198. The teeth 198 have a substantially triangular configuration which ends in a point. The teeth 198 are oriented in the radial direction R1 of the conductor, that is, the teeth 198 are spaced from one another along the radial direction R1 with the points of the teeth 198 having a width extending in the axial direction A1.

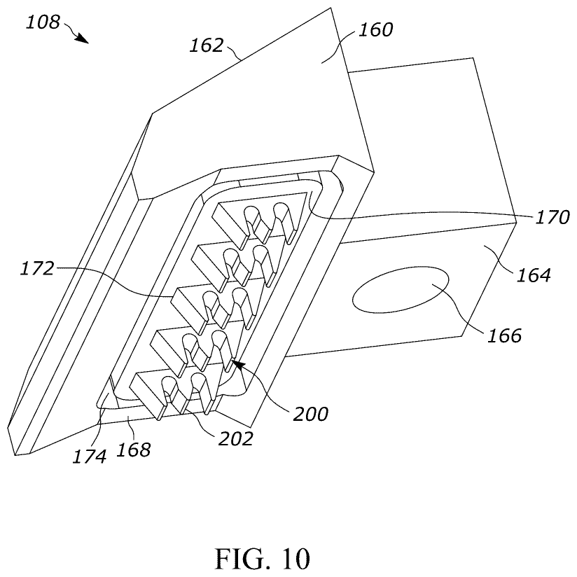

FIG. 10 shows an exemplary embodiment of a set of upper piercing members 200 positioned in the upper piercing member retainer 170. Each of the upper piercing members 200 includes a plurality of teeth 202. The teeth 202 have a substantially triangular configuration which ends in a point. The teeth 202 are oriented in the radial direction R1 of the conductor, that is, the teeth 202 are spaced from one another along the radial direction R1 with the points of the teeth 198 having a width extending in the axial direction A1.

FIG. 11 shows a sectional view of the connection 100. During operation a primary conductor can be loaded between the inner clamp 106 and one of the lower clamp 104 and upper clamp 108 and a tap conductor can be loaded between the inner clamp 106 and the other of the lower clamp 104 and upper clamp 108. The shear nut 114 can be tightened, which causes translation of the upper clamp 108 in the base, bringing the upper clamp 108 toward the lower clamp 104 with the inner clamp 106 being driven by the biasing member 116 toward the lower clamp 104. At a certain point, the force exerted by the clamp members 104, 106, 108 will cause the piercing members 190, 196, 200 to pierce the insulation of the received conductors. That is, the teeth 192, 194, 198, 202 will be driven through the insulation and into the conductive core of the conductor. An electrical connection can be formed by way of the inner piercing member as the first teeth 192 are in electrical communication with the second teeth 194. As the teeth 192, 194, 198, 202 pierce the conductors, the gaskets 176A,B, 182A,B can be compressed to form a seal around the openings made in the conductors. In certain configurations, the gaskets 176A,B, 182A,B are configured so that the respective teeth 192, 194, 198, 202 are positioned below an upper edge of the respective gaskets 176A,B, 182A,B. The orientation of the lower teeth 196 and the upper teeth 202 extending in the radial direction R1, or perpendicular to the axial direction A1, helps increase the electrical and mechanical connection between the connector 100 and the received conductors and helps to resist pull-out or dislodgement of the conductors.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. An electrical connector comprising:
a base;
a lower clamp connected to the base, the lower clamp including a conductor groove for receiving a conductor, the conductor having an axial direction and a radial direction;
an inner clamp connected to the base and moveable with respect to the lower clamp;
an upper clamp connected to the base and moveable with respect to the lower clamp;
a first insulation piercing member connected to the lower clamp, the first insulation piercing member including a plurality of first teeth, wherein the plurality of first teeth are spaced from one another in the radial direction;
a second insulation piercing member connected to the inner clamp; and
a third insulation piercing member connected to the upper clamp.

2. The electrical connector of claim 1, wherein the second insulation piercing member includes a lower set of teeth extending toward the lower clamp and an upper set of teeth extending toward the upper clamp.

3. The electrical connector of claim 2, wherein the lower set of teeth are spaced from each other in the axial direction and the upper set of teeth are spaced form each other in the axial direction.

4. The electrical connector of claim 1, wherein the upper clamp includes an upper cable groove and the lower clamp includes a lower cable groove.

5. The electrical connector of claim 1, wherein a lower gasket is connected to the lower clamp and positioned around the first insulation piercing member.

6. The electrical connector of claim 5, wherein the teeth are positioned below an upper edge of the gasket in an unstressed position.

7. The electrical connector of claim 1, wherein the third insulation piercing member includes a plurality of third teeth and wherein the plurality of third teeth are spaced from one another in the radial direction.

8. An electrical connector comprising:
a base;
a lower clamp integrally formed with the base, the lower clamp including a conductor groove for receiving a conductor, the conductor having an axial direction and a radial direction;
an inner clamp connected to the base and moveable with respect to the lower clamp;
an upper clamp connected to the base and moveable with respect to the lower clamp;
a fastener extending through at least a portion of the base, the inner clamp, and the upper clamp;
a first insulation piercing member connected to the lower clamp, the first insulation piercing member including a plurality of first teeth, wherein the plurality of first teeth are spaced from one another in the radial direction;
a second insulation piercing member connected to the inner clamp, wherein the second insulation piercing member includes a lower set of teeth extending toward the lower clamp and the lower set of teeth are spaced from each other in the axial direction; and
a third insulation piercing member connected to the upper clamp.

9. The electrical connector of claim 8, wherein the base has a crossbar, a first arm extending from the crossbar, and a second arm extending from the crossbar.

10. The electrical connector of claim 9, wherein the inner clamp includes a projection received between the first arm and the second arm.

11. The electrical connector of claim 8, wherein the lower clamp includes a lower channel and a gasket is received in the lower channel.

12. The electrical connector of claim 11, wherein the gasket includes curved upper surface configured to engage a conductor.

13. The electrical connector of claim 8, wherein the fastener includes a torque limiting shear head.

14. The electrical connector of claim 8, wherein the fastener extends through a biasing member.

15. The electrical connector of claim 14, wherein the biasing member is positioned between the upper clamp and the inner clamp.

16. An electrical connector comprising:
a base;
a lower clamp connected to the base, the lower clamp including a conductor groove for receiving a conductor, the conductor having an axial direction and a radial direction;
an inner clamp connected to the base and moveable with respect to the lower clamp;
an upper clamp connected to the base and moveable with respect to the lower clamp;
a first insulation piercing member connected to the lower clamp, the first insulation piercing member including a plurality of first teeth extending in a first direction;
a second insulation piercing member connected to the inner clamp, the second insulation piercing member including a plurality of second teeth extending in a second direction; and
a third insulation piercing member connected to the upper clamp.

17. The electrical connector of claim 16, wherein the first teeth extend perpendicular to the second teeth.

18. The electrical connector of claim 16, wherein the upper clamp includes an upper cable groove and the lower clamp includes a lower cable groove.

19. The electrical connector of claim 16, wherein a lower gasket is connected to the lower clamp and positioned around the first insulation piercing member.

20. The electrical connector of claim 19, wherein the teeth are positioned below an upper edge of the gasket in an unstressed position.
